(19) United States
(12) Patent Application Publication
(10) Pub. No.: US 2019/0087303 A1
(43) Pub. Date: Mar. 21, 2019

(54) SYSTEM, METHOD, AND APPARATUS FOR GATHERING INFORMATION

(71) Applicant: Alibaba Group Holding Limited, George Town (KY)

(72) Inventors: Hongbo Min, Shanghai (CN); Donglei Wu, Beijing (CN); Shengyue Zhao, Hangzhou (CN)

(21) Appl. No.: 16/135,751

(22) Filed: Sep. 19, 2018

Related U.S. Application Data
(63) Continuation-in-part of application No. PCT/CN2017/076035, filed on Mar. 9, 2017.

(30) Foreign Application Priority Data
Mar. 22, 2016 (CN) 201610166182.9

(51) Int. Cl. G06F 11/34; G06F 9/54; G06F 9/451

(52) U.S. Cl. CPC G06F 11/3438; G06F 2201/86; G06F 9/451; G06F 9/542

(57) ABSTRACT

An information gathering technique is disclosed. The technique includes retrieving information pertaining to a user event from a core layer of a layout engine. The technique further includes extracting information from an application interface based at least in part on the retrieved information pertaining to the user event. The technique can be implemented as a method, a system, or a computer program product.

### CROSS REFERENCE TO OTHER APPLICATIONS

This application is a continuation-in-part of and claims priority to International (PCT) Application No. PCT/CN2017/076035 entitled METHOD AND DEVICE FOR COLLECTING INFORMATION, AND INTELLIGENT TERMINAL filed Mar. 9, 2017 which is incorporated herein by reference for all purposes, which claims priority to People's Republic of China Patent Application No. 201610166182.9 entitled AN INFORMATION ACQUISITION METHOD AND DEVICE, AND A SMART TERMINAL filed Mar. 22, 2016 which is incorporated herein by reference for all purposes.

### FIELD OF THE INVENTION

The present application relates generally to the field of terminal device technology and more particularly to, a system, method and device for gathering information.

### BACKGROUND OF THE INVENTION

The increasing ubiquity of terminal devices such as mobile phones, tablet computers, laptop computers, personal computers, wearable devices, in-vehicle devices, and Internet of Things (IoT) devices (e.g., smart appliances, etc.) has led to improved ease and popularity for users to interact with such terminal devices. At the same time, terminal devices are becoming multiple purpose devices, capable of providing users with a variety of applications (APPs) such as Web Browsers, messaging programs, chatting programs, mobile payment programs, social media programs, home automation programs, media players (e.g., on-line music services, on-line movie services, on-line gaming services), game players, navigation guidance, and the like. Typically, the activities or patterns of activities of a user at a terminal device with regard to those applications reflect to a certain extent the user's preferences, habits, interest, intent, and the like. Therefore, by gathering and/or monitoring user activity data at a terminal device, such preferences, habits, interest and intent can be collected and analyzed.

Many conventional user behavioral data collecting techniques rely on the use of event tracking. This approach is implemented by the interfaces provided by the platform on which user behavioral data is collected. For example, commonly used interfaces include interfaces based on events and interfaces based on content (e.g., web page) transitions. Taking the Web API library for instance, mouseEvent, touchEvent, wheelEvent, gestureEvent, etc. can all be utilized to perform event tracking for the purposes of gathering user activities data in association with applications. In particular, for each interface, functions are configured to listen to the interfaces such that to obtain data generated at the interfaces. Taking an on-line shopping application for example, user activity data can be collected by tracking events generated by key operations. For instance, by listening to the interface based on a user's clicking operation, the number of times particular items of merchandise have been selected (e.g., clicked) by the user can be recorded. Even though such an event tracking mechanism can be used to collect information that the user has expressed interest in, such information collecting depends on the types of interfaces provided by the on-line shopping application. Therefore, the information collected is limited and general in nature, lacking necessary accuracy pertaining to the particularities associated with the information/content that is of interest to the user.

As such, there are several drawbacks associated with the conventional event tracking approach. First, the availability is limited to the standard interfaces provided by a platform. In other words, events can only be tracked via those provided interfaces. As the user behavior data can only be gathered at those interfaces provided, only limited types of data can be collected. Second, the event tracking approach collects all the data generated at the interfaces, as a result of which a comprehensive collection of data is obtained without differentiation amongst the importance or relevance of each collected piece of data. For example, an item of information that has only been accessed once by a user is not deemed as the content of interest to the user. However, because this item of information is gathered by the event tracking mechanism, this item of information is gathered as useful user activity data nevertheless.

Therefore, conventional techniques typically lack the necessary accuracy, relevance, or particularity in terms of collecting user activities data in relation to applications.

### BRIEF DESCRIPTION OF THE DRAWINGS

Various embodiments of the invention are disclosed in the following detailed description and the accompanying drawings.

FIG. 1 is a flow chart illustrating an example process for gathering information, in accordance with one or more embodiments of the present disclosure.

FIG. 2A is a flow chart illustrating another example process for gathering information, in accordance with one or more embodiments of the present disclosure.

FIG. 2B is a flow chart illustrating an example process for extracting information from a page based on the information pertaining to a user event, in accordance with one or more embodiments of the present disclosure.

FIG. 3 is a schematic diagram illustrating portions of an example architecture of an example system for gathering information, in accordance with one or more embodiments of the present disclosure.

FIG. 4 is a block diagram illustrating an example programmed computer system for gathering information, in accordance with one or more embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques for gathering information pertaining to user activities with regard to applications are described herein. Users' operations of and interactions with applications (e.g., web pages, image galleries, etc.) reflect quite accurately the preferences, habits, interest, intent, and the like thereof. On the other hand, those user activities are recorded at the system, for example, at the core layer of a layout engine in the form of user events. Therefore, by retrieving user events from the system, e.g., the core layer of a layout engine, information can be extracted from the applications based on the retrieved user events. This way, the degree of correlation and relevance is enhanced with regard to the information that captures the user's preferences, habits, interest, intent, and the like.

Further, by using user events recorded at a core layer of a layout engine, particular portions of the content of an application displayed at an interface thereof (e.g., web page, PDF document, etc.) can also be accurately determined. As used herein, a layout engine (also referred to as a browser engine) is configured to, among other things, render webpages or UI pages. Examples of layout engines include Blink™, WebKit™, Trident™, Gecko™, etc. The core layer of the layout engine implements core functions such as managing policies to layout user interface elements, networking access and resource management, event handling, graphics rendering, etc.

Thus, compared to conventional user data collecting techniques, embodiments of the present disclosure not only can collect user activity data to determine which applications (e.g., which web pages at what URLs, etc.) pique the user's interest, but also which portions of the content of such applications appeal to the user's interest. For example, based on the information captured in the user event “PinchUpdate” at the core layer of a layout engine, the specific portions of the content on the application interface (e.g., a web page, a user interface of an application, etc.) on which the user has performed the pinch operation can be accurately determined. For another example, based on the information of the user event “Select” recorded at the core layer of a layout engine, the specific portions of content on an application interface (e.g., a web page, an interface of an application, etc.) for which the user has performed select operations can also be accurately determined. As a result, with the information being extracted from an application interface (e.g., a web page, etc.) based on corresponding user events, the specific content which the user has zoomed upon, and the specific content the user has selected can be accurately identified and collected. In other words, the information gathered according to various embodiments of the present disclosure is more detailed, specific, and has a finer granularity with regard to the particular content that is of interest to a user. This way, the gathered information can be analyzed to provide results, knowledge, and insights with a higher accuracy. Equipped with such enhanced knowledge and insights, retailers, content providers, advertisers, and the like can adapt their on-line presence to improve their interaction and reach with customers.

Furthermore, by retrieving data from an application interface (e.g., a web page, etc.) based on user events recorded at the system (e.g., core layer of a layout engine), the collecting of information (e.g., user behavior data) is no longer limited to the types of interfaces provided by third party applications or platform providers, thereby broadening the application of the user activity data collection, and supplying more comprehensive and yet accurate user data.

As used herein, information gathering refers to collecting information/content in which a user has expressed interest at a terminal device. A terminal device includes, for example, a smart phone, a tablet computer, an e-book reader, an MP3 (Moving Picture Experts Group Audio Layer III) player, an MP4 (Moving Picture Experts Group Audio Layer IV) player, a laptop computer, an in-vehicle device, a desktop computer, a set-top box, a smart TV, a wearable device, an IoT device, and the like.

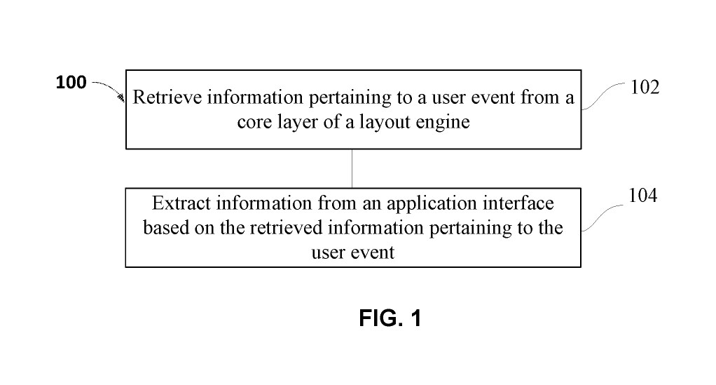

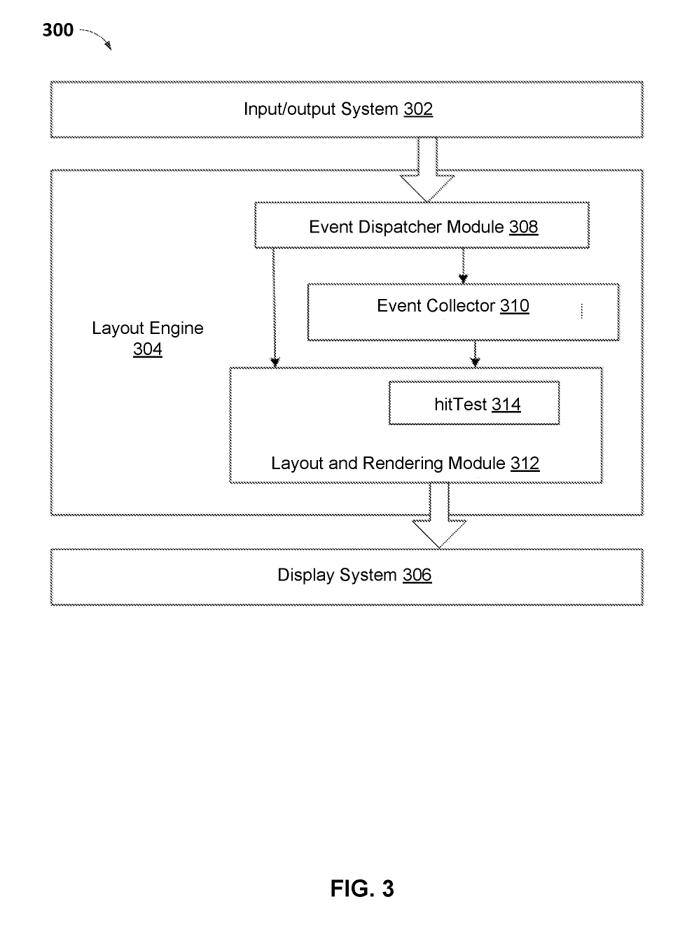

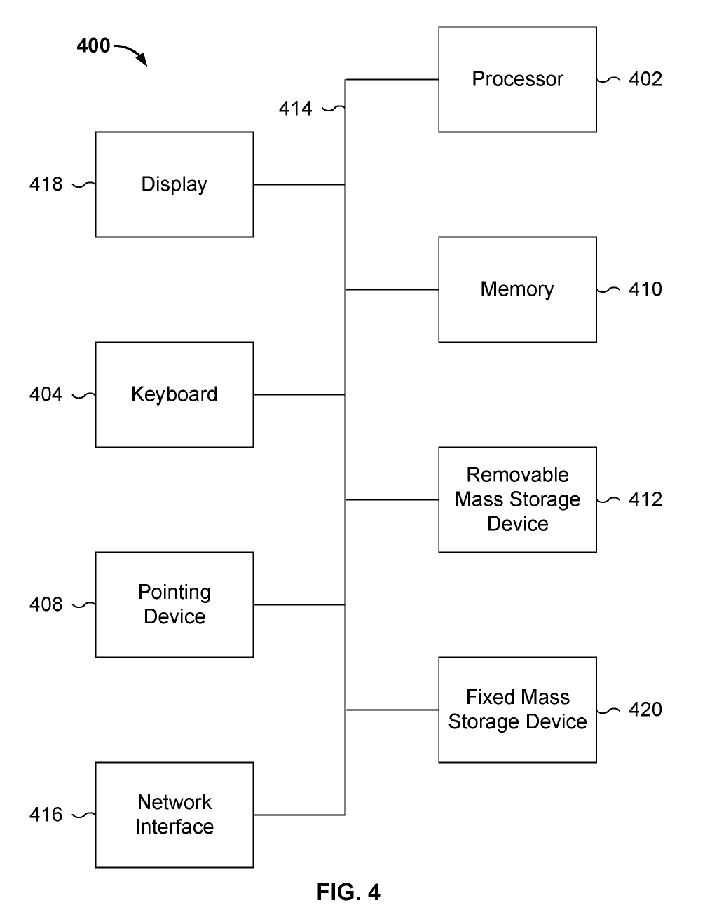

FIG. 1 illustrates a flow chart of an example process for gathering information, in accordance with an embodiment of the present disclosure. Process 100 can be implemented by, for example but not limited to, system 300 of FIG. 3, or system 400 of FIG. 4.

Process 100 starts at 102, where information pertaining to a user event is retrieved from a core layer of a layout engine.

In general, operations performed by a user at a terminal device are captured in the form of events (e.g., user events) at the system (e.g., core layer of a layout engine). In other words, the system keeps a record of all the events corresponding to a user's operations. Any suitable techniques can be applied herein to retrieving user events from the system (e.g., the core layer of a layout engine) without limitation.

At 104, information is extracted from an application interface based on the information pertaining to the user event retrieved from the core layer of a layout engine.

In this example, a page displayed at the terminal device is used to illustrate the user's operations with respect to an application. As used herein, a page refers to any application's user interface displayed at the terminal device. For example, a page includes, but is not limited to, a web page, a page of an application (e.g., a page of an e-commerce application, etc.).

In general, the user's interaction with the page can accurately reflect the user's preferences, habits, interest, intent, and the like. For example, when a user is interested in a particular item of content of the page, the user is highly likely to pause at the current page navigation location so as to read the particular item of content carefully and thoroughly. As such, the scrolling speed on the page input by the user becomes much slower than the user's average scrolling speed at pages. For another example, when a user is interested in a particular item of content of the page, the user might select the entire or portions of the particular item of content, with which subsequent operations such as copy and/or paste, drag and/or drop are performed by the user. For yet another example, when the user is interested in a particular item of content of the page, the user might zoom in on the entire or portions of the particular item of content in order to read or view it in an enlarged state.

For various user operations of and interactions with the page (e.g., the above-described selecting, copying, pasting, and long-pressing of items of content of the page, tapping, scrolling and zooming of the page, etc.), the core layer of a layout engine keeps a copy of these user actions in the corresponding records of user events. For example, user events recorded at the core layer of a layout engine corresponding to user operations include, but are not limited to, ScrollStart events (user starting to scroll a page), ScrollUpdate events (user continuing to scroll on a page), ScrollEnd events (user ending scrolling on a page), PinchStart events (user beginning to zoom a page), PinchUpdate events (user in the middle of zooming a page), PinchEnd events (user ending the zooming of a page), LongPress events (user long pressing on a page), Clickevents (user clicking on a location on a page, the location corresponding to an item of content of a page, or elements of a page), Selectevents (user selecting an item of content in a page), Copyevents (user copying content selected from a page), and the like.

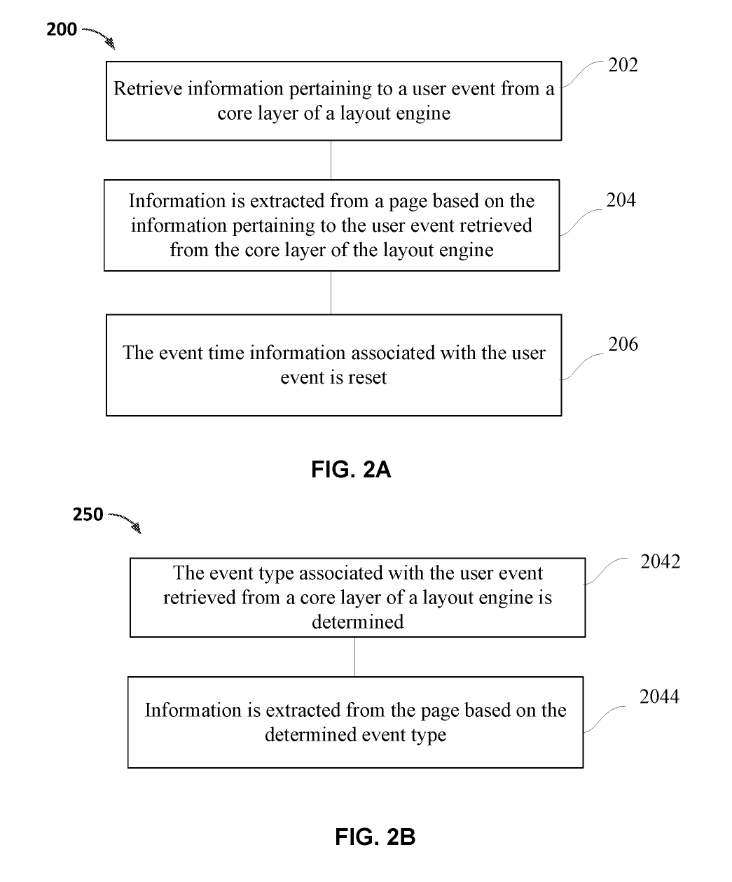

As a user's operations at a page can accurately reflect the user's preferences, habits, interest, intent and the like, and such user operations are recorded at the core layer of a layout engine in the form of user events, the extraction of information from the page based on the user events recorded at the core layer of a layout engine leads to a higher degree of relevance that matches the extracted information with the user's actual preferences, habits, interest, intent, and the like. More details are described with reference to FIG. 2A below.

FIG. 2A is a flow chart illustrating another example process for gathering information, in accordance with an embodiment of the present disclosure. Process 200 can be implemented by, for example but not limited to, system 300 of FIG. 3 or system 400 of FIG. 4.

In this example, a web engine kernel (e.g., core layer) environment (e.g., Safari, Trident™, Gecko™, WebKit™, etc.) is used to illustrate the collecting of information with respect to applications. Such core layer of a layout engine can be implemented in any suitable design, for example, monolithic kernels, microkernels, or modular kernels. It should be understood that any kernel environment can be applied herein without limitation. It should also be understood that the information extracted from an application (e.g., a web page, etc.) includes, but is not limited to, textual information, imagery information, audio information, video information, website links, and the like. In some embodiments, the information extracted from the application (e.g., the web page, etc.) includes information processed by use of various types of analysis such as semantic analysis, image recognition analysis, and the like. For example, the information extracted from the application can include information as one or more keywords parsed from the textual information retrieved from the application, subject information (e.g., landmarks, people, sceneries, etc.) recognized from the images or portions of the images retrieved from the application by use of techniques such as machine learning, artificial intelligence (AI) algorithms.

Process 200 starts at 202, where information pertaining to a user event at the core layer of a layout engine is retrieved.

In this example, the information pertaining to the user event at the core layer of a layout engine is retrieved from the record associated with the core layer of a layout engine. Here, the kernel (e.g., core layer) of the layout engine is configured to record user events based on inputs such as user gestures. For example, a user event identifier recorded in a kernel of a layout engine is retrieved, the user event identifier being determined based at least in part on user gestures.

In some embodiments, the layout engine is implemented as a module that is responsible for rendering interfaces for applications, and processing events associated therewith. Typical layout engines include, for example, browser engines, digital typesetting engines, layout managers, and the like. A browser engine (e.g., a web engine such as Trident™, Gecko™ WebKit™, etc.) refers to software components of a web browser that handle the layout of a web page. A digital typesetting engine refers to software components used during document creation, viewing, editing, and the like. For example, a PDF reader includes a digital typesetting engine. A layout manager refers to software components in a GUI toolkit that configure various interface elements according to system constraints, user designs, etc. For example, a user interface (UI) framework implemented on top of an operating system (OS) includes a layout manager. As mentioned above, the kernel of a web engine is used to illustrate an example retrieval of user events from the core layer of a layout engine, e.g., the web engine's core layer of a layout engine.

At 204, information is extracted from a page (e.g., a web page) based on the information pertaining to the user event retrieved from the core layer of a layout engine. More details are described with reference to FIG. 2B below.

At 206, the event time associated with the user event corresponding to the user event information at the core layer of a layout engine is reset.

In some embodiments, to extract information from the page based on the user event retrieved at the core layer of a layout engine involves the time information associated with various types of user events. In order to ensure the consistency of the time information associated with various types of events, and the accuracy of the information extraction results, the event time associated with the user event is reset.

In some embodiments, the event time associated with the user event at the core layer of a layout engine can be reset at any time as appropriate. For example, the event time can be reset once the extracting of the information based on the corresponding user event is concluded. Or, the event time can be reset when the page is transitioned to another page. Or, the event time can be reset when the screen of the terminal device enters a locked screen state. Or, the event time can be reset before the information is extracted based on the corresponding user event.

As such, as the event time associated with the user event at the core layer of a layout engine can be reset at any appropriate time, step 206 can be performed before or subsequent to any one of steps 202-204, without limitation. By resetting the time associated with the user event at 206, it is ensured that the consistency of timing associated with various types of user events is maintained, especially with respect to the accuracy of the time duration computed as described above. As a result, erroneous information extraction or omission of information extraction due to the miscomputing of time information can be avoided, increasing the efficiency of information gathering.

FIG. 2B is a flow chart illustrating an example process for extracting information from a page based on the information pertaining to a user event, in accordance with an embodiment of the present disclosure. Process 250 can implement, for example but not limited to step 204 of FIG. 2A.

Process 250 starts at 2042, where the event type associated with the user event retrieved from the core layer of a layout engine is determined.

At 2044, information is extracted from the page based on the determined event type.

In some embodiments, the event types include, but are not limited to, page scrolling events, page zooming events, and page editing events. Details with regard to extracting information from the page by use of those types of events are described below.

In some cases, when the event type is determined as a page scrolling event, step 2044 includes analyzing the page scrolling event to obtain the page scrolling rate, and extracting information from the page based on the page scrolling rate.

In particular, in order to extract information from the page based on the page scrolling rate, the page scrolling rate is compared to a pre-set rate threshold. If the page scrolling rate is less than the pre-set rate threshold, a page start location and a page end location corresponding to the page scrolling event are determined. Subsequently, the information is extracted from the page that is contained between the page start location and the page end location.

In some embodiments, the page scrolling rate is configured as the scrolling rates along the X axis or the Y axis of the page when the page scroll event occurs. Here, the pre-set rate threshold can be configured in advance based on, for example, an average scrolling rate associated with a normal human reading rate (e.g., empirical data showing a reading rate of 10 cm/s). Suppose such average scrolling rate is determined as S0, the pre-set rate threshold is set as S0. Here, when the scrolling rate along either the X axis or the Y axis is less than the pre-set rate threshold, it is determined that the page scrolling is less than the pre-set threshold rate.

In some other cases, when the event type is a page scrolling event, step 2044 includes analyzing the page scrolling event to obtain a page scrolling time duration, and extracting information from the page based on the page scrolling time duration.

In particular, in order to obtain the page scrolling time duration, the time when the page scrolling event is triggered and the opening time when the page is opened are obtained. Thus, information is extracted from the page based on the page scrolling duration, which is computed as the duration of time between the triggering time of the page scrolling event and the opening time of the page. When the computed duration of time is greater than a first pre-set time duration threshold (which indicates that the user likely has viewed the page for a period of time greater than the first pre-set time duration threshold), the information currently displayed at the visible area on the screen is extracted from the page.

In some embodiments, the triggering time of the page scrolling event is configured as the time when the page scrolling event is triggered, and the opening time of the page is configured as the time when the page is first opened. In some embodiments, the opening time of the page can be configured (e.g., the timer can be set) as the time when the page becomes the active window again.

In some other embodiments, the page scrolling time duration includes the triggering time associated with the currently displayed portion of the page (e.g., the time when the page scrolling event is triggered to cause the current portion of the page to be displayed), and the triggering time associated with the previously displayed portion of the page (e.g., the time when the page scrolling event is triggered to cause the portion of the page to be displayed prior to the currently displayed portion of the page). Thus, the information is extracted from the page based on the page scrolling time duration, which is computed as the duration between the triggering time associated with the currently displayed portion of the page and the triggering time associated with the previously displayed portion of the page. In some embodiments, the currently displayed portion of the page is the portion of the page that is currently visible to a user on a terminal device, and the previously displayed portion of the page is the portion of the page that is displayed immediately prior to the currently displayed portion of the page, e.g., the previous visible portion of the page on the terminal. If the computed time duration is greater than a second pre-set duration threshold, the information currently displayed at the visible area on the screen is extracted from the page.

In some embodiments, the triggering time associated with the page scrolling event on the currently displayed portion of the page is configured as the time when the scrolling event is triggered, and the triggering time associated with the scrolling event on the previously displayed portion of the page is configured as the time when the previous page scrolling event is triggered. In some embodiments, the currently displayed portion of the page and the previously displayed portion of the page are two continuous portions that are consecutive to each other, e.g., one displayed and visible immediately prior to the other being displayed and visible.

In some embodiments, the first pre-set duration threshold and the second pre-set duration threshold are configured in advance based on an average time duration a user would normally spend on reading or viewing the information displayed at the visible area on a terminal device. For example, if the average time spent to read the entire content displayed in the area visible (e.g., an active browser window) on the screen of the terminal device is determined as N seconds, the value of N seconds is configured as the first pre-set time duration threshold, as well as the second pre-set time duration threshold. In some embodiments, the average time duration is determined based on factors such as the size of the area visible on the screen, the font size and font type of the content displayed in the visible area, and the like. For example, given the particular size of the visible window on the screen, and the font size and the font face of the content displayed, a total count of words displayed can be computed. Given empirical data such as the average reading speed is about 200 to 250 words per minute for leisure reading, the amount of average time a user would spend on viewing the page can be computed. It should be understood that any techniques can be applied herein to configuring the first and second pre-set time duration thresholds, without limitation.

In some cases, when the event type is a page zooming event, step 2044 can be implemented by analyzing the page zooming event to retrieve the first set of coordinates corresponding to the page zooming event, and extracting the information contained at the first set of coordinates in the page.

In some embodiments, the first set of coordinates corresponding to the page zooming event is configured as the set of coordinates associated with the center point of the zooming gesture, e.g., the center point of the multiple contact points detected upon the user commencing a zooming/pinching operation at a location on the page.

In some embodiments, the first set of coordinates corresponding to the page zooming event is configured as the set of coordinates associated with a tapping gesture (e.g., double tapping or triple tapping to zoom in to enter a full screen magnification, or to zoom in at a particular target item displayed at the screen). In some embodiments, the first set of coordinates can be configured as the set of coordinates associated with the specific target the user taps on.

In some cases, when the event type is a page editing event, step 2044 includes analyzing the page editing event to retrieve the second set of coordinates corresponding to the page editing event, and extracting the information located at the second set of coordinates from the page.

In some embodiments, the page editing events include, but are not limited to, clicking, selecting copying, pasting, cutting, dragging, dropping, hovering, and the like, performed with respect to the page. In some embodiments, the second set of coordinates corresponding to the page editing events is configured as the set of coordinates corresponding to various editing operations such as the set of coordinates corresponding to a selecting operation, the set of coordinates corresponding to a clicking operation, etc.

In some embodiments, the information is extracted from the page based on the page editing events only when it is determined that the page editing events correspond to edit targets (e.g., a selected text block, an editable text block, etc.). In other words, the editing detected is performed on a non-null (e.g., non-empty) target on the page. Thus, it is ensured that the computing resources are not wasted on collecting information from a null target of the page, thereby increasing the efficiency of information gathering.

In some embodiments, extracting the information from the page (e.g., the afore-described extracting of the information located at the first set of coordinates from the page, and/or extracting of the information located at the second set of coordinates from the page, etc.) can be implemented using the HitTest mechanism provided by a layout engine provided by the iOS® SDK. For example, a hitTest call traverses, starting from the top-view of the view hierarchy associated with a window, through each view in the view hierarchy, by calling pointInside function for each view to determine which view should receive a specified point associated with a user event (e.g., a click, a touch, etc.), e.g., the specified point hits (e.g., is located inside) which view. Here, the HitTest mechanism can be used to determine information pertaining to user events (e.g., MouseUp, MouseDown, MouseOver, Click, DoubleClick (DblClick) for the purpose of extracting information from a page. It should be understood that any suitable techniques can be applied herein to the extracting of information from a page, without limitation.

FIG. 3 illustrates a schematic diagram of portions of an example architecture of an example system for gathering information, in accordance with an embodiment of the present disclosure. System 300 can be used to implement, for example not limited to, process 100 of FIG. 1 or process 200 of FIG. 2A.

System 300 includes an input/output system 302, a layout engine 304, and a display system 306.

Input/output system 302 is configured to receive a user's input operations with respect to the terminal device. Input/output system 302 is also configured to transmit the outputted data to the user in response to output operations.

Layout engine 304 is configured to include an event dispatcher module 308, an event collector 310, and a layout and rendering module 312.

Event dispatcher module 308 is configured to allow access or monitoring of user events at the core layer of a layout engine. Event collector 310 is configured to retrieve user events from the core layer of a layout engine. Layout and rendering module 312 is configured to extract information from the page based on the user events retrieved from the core layer of a layout engine. In some embodiments, layout and rendering module 312 is configured to utilize the above-described hitTest 314 function to extract information from the page.

Display system 306 is configured to display information of the page.

The modules described above can be implemented as software components executing on one or more processors, as hardware components such as programmable logic devices (e.g., microprocessors, field-programmable gate arrays (FPGAs), digital signal processors (DSPs), etc.), Application Specific Integrated Circuits (ASICs) designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present application. The modules may be implemented on a single device or distributed across multiple devices. The functions of the modules may be merged into one another or further split into multiple sub-modules.

FIG. 4 is a functional diagram illustrating an embodiment of a programmed computer system for information gathering. As will be apparent, other computer system architectures and configurations can be used to gather information. Computer system 400, which includes various subsystems as described below, includes at least one microprocessor subsystem (also referred to as a processor or a central processing unit (CPU)) 402. For example, processor 402 can be implemented by a single-chip processor or by multiple processors. In some embodiments, processor 402 is a general purpose digital processor that controls the operation of the computer system 400. Using instructions retrieved from memory 410, the processor 402 controls the reception and manipulation of input data, and the output and display of data on output devices (e.g., display 418). In some embodiments, processor 402 includes and/or is used to provide the information gathering.

Processor 402 is coupled bi-directionally with memory 410, which can include a first primary storage area, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 402. Also as is well known in the art, primary storage typically includes basic operating instructions, program code, data, and objects used by the processor 402 to perform its functions (e.g., programmed instructions). For example, memory 410 can include any suitable computer readable storage media, described below, depending on whether, for example, data access needs to be bi-directional or uni-directional. For example, processor 402 can also directly and very rapidly retrieve and store frequently needed data in a cache memory (not shown).

A removable mass storage device 412 provides additional data storage capacity for the computer system 400 and is coupled either bi-directionally (read/write) or uni-directionally (read only) to processor 402. For example, storage 412 can also include computer readable media such as magnetic tape, flash memory, PC-CARDS, portable mass storage devices, holographic storage devices, and other storage devices. A fixed mass storage 420 can also, for example, provide additional data storage capacity. The most common example of fixed mass storage 420 is a hard disk drive. Mass storages 412, 420 generally store additional programming instructions, data, and the like that typically are not in active use by the processor 402. It will be appreciated that the information retained within mass storages 412 and 420 can be incorporated, if needed, in standard fashion as part of memory 410 (e.g., RAM) as virtual memory.

In addition to providing processor 402 access to storage subsystems, bus 414 can also be used to provide access to other subsystems and devices. As shown, these can include a display 418, a network interface 416, a keyboard 404, and a pointing device 408, as well as an auxiliary input/output device interface, a sound card, speakers, and other subsystems as needed. For example, the pointing device 408 can be a mouse, stylus, track ball, or tablet, and is useful for interacting with a graphical user interface.

The network interface 416 allows processor 402 to be coupled to another computer, computer network, or telecommunications network using a network connection as shown. For example, through the network interface 416, the processor 402 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 402 can be used to connect the computer system 400 to an external network and transfer data according to standard protocols. For example, various process embodiments disclosed herein can be executed on processor 402, or can be performed across a network such as the Internet, intranet networks, or local area networks, in conjunction with a remote processor that shares a portion of the processing. Additional mass storage devices (not shown) can also be connected to processor 402 through network interface 416.

An auxiliary I/O device interface (not shown) can be used in conjunction with computer system 400. The auxiliary I/O device interface can include general and customized interfaces that allow the processor 402 to send and, more typically, receive data from other devices such as microphones, touch-sensitive displays, transducer card readers, tape readers, voice or handwriting recognizers, biometrics readers, cameras, portable mass storage devices, and other computers. Persons skilled in the art may clearly understand that, for the sake of descriptive convenience and streamlining, one may refer to the processes in the aforesaid method embodiments that correspond to specific work processes of the systems, devices, and units described above. They will not be discussed further here.

In one typical configuration, the computation equipment comprises one or more processors (CPUs), input/output interfaces, network interfaces, and memory.

Memory may include such forms as volatile storage devices in computer-readable media, random access memory (RAM), and/or non-volatile memory, such as read-only memory (ROM) or flash memory (flash RAM). Memory is an example of a computer-readable medium.

Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digit multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include temporary computer-readable media, (transitory media), such as modulated data signals and carrier waves.

A person skilled in the art should understand that embodiments of the present application can be provided as methods, systems, or computer program products. Therefore, the present application can take the form of an entirely hardware embodiment, an entirely software embodiment, or an embodiment that combines software and hardware aspects. In addition, the present application can take the form of computer program products implemented on one or more computer-operable storage media (including but not limited to magnetic disk storage devices, CD-ROMs, and optical storage devices) containing computer operable program codes.

The present application is described with reference to flowcharts and/or block diagrams based on methods, devices (systems), and computer program products of embodiments of the present application. Please note that each process and/or block within the flowcharts and/or block diagrams and combinations of processes and/or blocks within the flowcharts and/or block diagrams can be realized by computer commands. These computer program instructions can be provided to general-purpose computers, special-purpose computers, embedded processors, or processors of other data-processing devices to give rise to a machine such that the instructions by the computers or by the processors of other programmable data-processing devices give rise to devices used to implement the functions specified in one or more processes in a flowchart and/or in one or more blocks in a block diagram.

These computer program instructions can also be stored in computer-readable memory that can guide computers or other programmable data-processing devices to operate according to specific modes, with the result that the instructions stored in this computer-readable memory give rise to products that include command devices. These command devices implement the functions specified in one or more processes in a flow chart and/or one or more blocks in a block diagram.

These computer program instructions can also be loaded onto a computer or other programmable data-processing device, with the result that a series of operating steps are executed on a computer or other programmable device so as to give rise to computer processing. In this way, the instructions executed on a computer or other programmable device provide steps for implementing the functions specified by one or more processes in a flow chart and/or one or more blocks in a block diagram.

Although preferred embodiments of the present application have already been described, persons skilled in the art can make other alterations and modifications to these embodiments once they grasp the basic creative concept. Therefore, the attached claims are to be interpreted as including the preferred embodiments as well as all alterations and modifications falling within the scope of the present application.

Obviously, a person skilled in the art can modify and vary the present application without departing from the spirit and scope of the present application. Thus, if these modifications to and variations of embodiments of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
retrieving, from a core layer of a layout engine information pertaining to a user event; and
extracting information from an application interface based at least in part on the retrieved information pertaining to the user event.

2. The method of claim 1, wherein the extracting of the information from the application interface based at least in part on the user event comprises:
determining an event type associated with the user event; and
extracting the information from the application interface based at least in part on the determined event type.

3. The method of claim 2, wherein the event type comprises a page scrolling event, a page zooming event, a page editing event, or any combination thereof.

4. The method of claim 2, wherein:
the event type comprises a page scrolling event; and
the extracting of the information from the application interface based at least in part on the determined event type comprises:
analyzing the page scrolling event to retrieve a page scrolling rate; and
extracting the information from the application interface based at least in part on the page scrolling rate.

5. The method of claim 4, wherein the extracting of the information from the application interface based at least in part on the page scrolling rate comprises:
comparing the page scrolling rate against a pre-set scrolling rate threshold;
in response to the page scrolling rate being less than the pre-set scrolling rate threshold, determining a start location and an end location corresponding to the page scrolling event; and
extracting the information located between the start location and the end location from the application interface.

6. The method of claim 2, wherein:
the event type comprises a page scrolling event; and
the extracting of the information based at least in part on the determined event type comprises:
analyzing the page scrolling event to retrieve a page scrolling time duration; and
extracting the information from the application interface based at least in part on the page scrolling time duration.

7. The method of claim 6, wherein:
the page scrolling time duration comprises: a triggering time associated with the page scrolling event, and an opening time when the application interface is opened; and
the extracting of the information from the application interface based at least in part on the page scrolling time duration comprises:
computing a time difference between the triggering time associated with the page scrolling event and the opening time to obtain a first time duration; and
in response to the first time duration being greater than a first pre-set time duration threshold, extracting the information contained in a visible area of a screen from the application interface.

8. The method of claim 6, wherein the page scrolling time duration comprises: a triggering time associated with the page scrolling event, and a triggering time associated with a previous page scrolling event, and wherein the extracting of the information from the application interface based at least in part on the page scrolling time duration comprises:
computing a time difference between the triggering time associated with the page scrolling event and the triggering time associated with the previous page scrolling event to obtain a second time duration; and
in response to the second time duration being greater than a second pre-set time duration threshold, extracting the information contained in a currently visible area of a screen from the application interface.

9. The method of claim 1, wherein the application interface includes a page displayed in a web browser.

10. The method of claim 2, wherein:
the event type comprises a page zooming event; and
the extracting of the information from the application interface based at least in part on the determined event type comprises:
analyzing the page zooming event to retrieve a set of coordinates corresponding to the page zooming event; and
extracting information contained at the set of coordinates from the application interface.

11. The method of claim 2, wherein: the event type comprises a page editing event; and the page editing event includes at least one of: click, selection, copy, paste, cut, drag, drop, and hover operations with respect to the application interface.

12. The method of claim 11, wherein the extracting of the information from the application interface based at least in part on the determined event type comprises:
analyzing the page editing event to retrieve a set of coordinates corresponding to the page editing event; and
extracting information contained at the set of coordinates from the application interface.

13. The method of claim 11, wherein an edit target corresponding to the page editing event is not empty.

14. The method of claim 1, further comprising resetting an event time associated with the user event.

15. The method of claim 1, wherein the retrieving of the information pertaining to the user event comprises:
retrieving a user event identifier recorded in a core layer of a layout engine, the user event identifier being determined based at least in part on user gestures.

16. The method of claim 1, wherein the information extracted from the application interface comprises: textual information, imagery information, audio information, video information, and website links.

17. The method of claim 1, wherein the information includes user operation information.

18. A system for gathering information, comprising:
one or more processors configured to:
retrieve information pertaining to a user event from a core layer of a layout engine; and
extract information from an application interface based at least in part on the retrieved information pertaining to the user event; and
one or more memories coupled to the one or more processors, configured to provide the one or more processors with instructions.

19. The system of claim 18, wherein to extract the information from the application interface based at least in part on the user event comprises to:
determine an event type associated with the user event; and
extract the information from the application interface based at least in part on the determined event type.

20. The system of claim 19, wherein the event type comprises a page scrolling event, a page zooming event, a page editing event, or any combination thereof.

21. A computer program product, the computer program product being embodied in a tangible computer readable storage medium and comprising computer instructions for:
retrieving information pertaining to a user event from a core layer of a layout engine; and
extracting information from an application interface based at least in part on the retrieved information pertaining to the user event.
